(19) United States
(12) Patent Application Publication
(10) Pub. No.: US 2010/0182912 A1
(43) Pub. Date: Jul. 22, 2010

(54) METHOD, SYSTEM, AND DEVICES FOR INFORMING A TERMINAL ABOUT FAILURE IN RESOURCE RESERVATION

(75) Inventors: Jukka Hongisto, Helsinki (FI); Stefan Baggstrom, Tampere (FI); Mari-Jaana Pelkonen, Espoo (FI); Kaisu IIsakkila, Espoo (FI); Woonhee Hwang, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/442,923

(22) PCT Filed: Sep. 26, 2007
(86) PCT No.: PCT/IB2007/053902

§ 371 Date: Mar. 2, 2010

(30) Foreign Application Priority Data
Sep. 27, 2006 (US) 60847367

(51) Int. Cl. H04J 3/14

(52) U.S. Cl. 370/242

(57) ABSTRACT

In an embodiment, a network decides on quality of service, QoS, to be used for information flow between the network and a terminal, and on whether the terminal is to be informed on an unsuccessful resource reservation needed for providing the quality of service. The network informs the terminal depending on the decision result. An application running in the terminal, such as a QoS aware application, is provided with information about failure in resource reservation, and a session setup is canceled, or a default QoS is used, or session parameters are renegotiated, in response to the information about failure.

The invention generally relates to communication, and may be applied for informing a terminal about a failure in reserving a resource. The invention may be applied e.g. within a quality of service, QoS, task such as a NEP_INC_{—}3G SAE/LTE quality of service, QoS, task.

System Architecture Evolution, SAE,/Long Term Evolution, LTE, requires network controlled resource reservation, because a terminal is not expected to be aware of layer 3, L3, QoS. In the Long Term Evolution (LTE) and 3GPP System Architecture Evolution (SAE), the network has full control of quality of service, QoS, and the terminal is automatically given only the radio L2 (layer 2) information, which is required to map services to right radio bearers. It is assumed that there is no L3 (layer 3) QoS negotiation between core network and the terminal, i.e. terminal is not expected to be aware of L3 QoS.

SAE/LTE may be implemented on top of existing network. The terminals may be multimode terminals supporting LTE and 2G/3G access technologies. The QoS mechanism in 3G networks requires support from the terminal and applications and therefore it is assumed that actual or future multimode terminals have QoS capabilities for 3G access network usage. This requires that applications are able to request QoS and the terminal is able to modify the QoS request to secondary PDP context request when the terminal is attached to 3G access network. For example QoS aware SIP application is supporting usage of pre-conditions [RFC 3312] and before the SIP signalling can be finally acknowledged the terminal is waiting for information of the success of the resource reservation (secondary PDP context response).

In case of full network controlled resource reservation, the terminal is not allowed to request QoS. In case of successful bearer setup, the SAE radio bearer setup messaging is used to transfer QoS information to the terminal. If the bearer setup fails, the terminal is not automatically getting any indication of the failure. If an application running in terminal is not aware of failure in resource reservation then the overall speed of operation may be reduced due to unnecessary waiting time, and the end user's quality of experience may be compromised.

Embodiments of the invention provide a method comprising a network decides on quality of service, QoS, to be used for information flow between the network and a terminal,

the network decides on whether the terminal is to be informed on an unsuccessful resource reservation needed for providing the quality of service, and

the network informs the terminal depending on the decision result. The resource reservation can e.g. be a radio resource reservation.

The terminal may be a multimode terminal, or not be allowed to request QoS. In case of successful bearer setup for providing the quality of service, radio bearer setup messaging may be used to transfer QoS information to the terminal, or, if the bearer setup fails, an indication of the failure may be sent to the terminal.

In accordance with at least one or all of the embodiments of the invention, an application running in the terminal, such as a QoS aware application, may be provided with information about failure in resource reservation, and a session setup may be canceled, or a default QoS be used, or session parameters be renegotiated, in response to the information about failure.

An application may be able to request QoS and the terminal be able to modify a QoS request to e.g. a secondary PDP context request when the terminal is attached to a 3G access network. At least one of the network and the terminal may be a System Architecture Evolution, SAE, or LTE, long term evolution, network or terminal.

The terminal e.g. transfers received information on successful or unsuccessful resource reservation to an application layer. The terminal may be a network card or a mobile handset or mobile phone.

The network can be adapted to inform the terminal on the decision result by sending a “network busy” message, if a dedicated bearer setup fails.

A network entity such as a mobility management entity, may comprise means for deciding on quality of service, QoS, to be used for information flow between a network and a terminal, means for deciding on whether the terminal is to be informed on an unsuccessful resource reservation needed for providing the quality of service, and means for informing the terminal depending on the decision result.

A system may comprise a network entity and a terminal as defined above.

Embodiments provide a computer program product or module loadable into a network entity or terminal, comprising portions for executing the above method.

In accordance with embodiments of the invention, information of unsuccessful or successful resource reservation may be transferred to a terminal or up to the application layer thereof. This specification explains the behaviour and structure of embodiments such as a terminal and a network or network entity to transfer information of successful or unsuccessful resource reservation up to the application layer.

QoS aware applications can benefit from information about failure in resource reservation so as to be able to gracefully cancel a session setup or to renegotiate the session parameters if default QoS is not to be concerned for the application. Without failure indication QoS aware applications may have unstable behaviour when waiting for resource reservation feedback before completing the session setup.

In case of e.g. IP multimedia subsystem, IMS, voice-over-internet protocol, VoIP, the network is able to terminate the session setup in case of resource reservation failure to prevent “ghost calls” without sufficient resources. If the QoS awareness of the application is supported with the failure indication, the session setup is not necessarily terminated, but the decision how to continue may be left for the application itself.

For cost efficiency, in at least one of the embodiments, the same application implementations used in 3G access is functioning as well in LTE access technology. The applications have already been implemented for 2G/3G devices and if the same application versions can be used in future multimode terminals, there will be savings in software development. To support the usage of QoS aware applications in multimode terminals, according to at least one of the embodiments not only the success but also the failure of bearer setup is informed to the terminal.

Some or all of the embodiments of the invention are able to solve a problem of QoS aware application usage in 2G/3G/3G LTE capable terminal.

Thus, according to the present invention, the following is for example provided:

A Method, comprising deciding, on a network or network entity, on quality of service, QoS, to be used for information flow between the network and a terminal, deciding, on a network or network entity, on whether the terminal is to be informed on an unsuccessful resource reservation needed for providing the quality of service, and informing the terminal depending on the decision result.

According to aspects of that method,
the decision on whether the terminal is to be informed on an unsuccessful resource reservation, is based on a message received from the terminal;
the network is a System Architecture Evolution, SAE, or LTE, long term evolution, network, and the resource reservation is a radio resource reservation;
the network or network entity sends an indication message such as a “network busy” message to inform the terminal about the success or failure of the resource reservation.

An Apparatus, comprising: a receiving unit to receive information about failure regarding resource reservation.

According to aspects of that apparatus
the apparatus is a terminal comprising at least one of: a multimode terminal, a terminal that is not allowed to request QoS, and a terminal that is adapted to receive, in case of successful bearer setup for providing the quality of service, a radio bearer setup messaging to transfer QoS information to the terminal, or, if the bearer setup fails, an indication of the failure;
the apparatus further comprises a platform adapted to run at least one application, such as a QoS aware application, a processor configured to inform the application with information about failure in resource reservation, and configured to cancel a session setup, or to use a default QoS, or to renegotiate session parameters, in response to the information about failure;
the apparatus further comprises a transmitting unit to send a notice that QoS aware is supported by the apparatus;
wherein the application is able to request QoS and the apparatus is adapted to modify a QoS request to a secondary PDP context request when the apparatus is attached to a network, such as a 3G access network, permitting PDP context;
wherein the application is a SIP application.
wherein the apparatus is a System Architecture Evolution, SAE, or LTE, long term evolution, terminal.
wherein the apparatus is adapted to transfer received information on successful or unsuccessful resource reservation to an application layer.
wherein the apparatus is a network card, chipset, terminal, handset, mobile handset, or mobile phone.
wherein the apparatus is adapted to receive an indication message to inform the apparatus about the success or failure of the resource reservation if a dedicated bearer setup fails.
wherein the terminal is adapted to receive a “network busy” message if a dedicated bearer setup fails.

An Apparatus, comprising a unit deciding on quality of service, QoS, to be used for information flow between a network and a terminal, a unit deciding on whether the terminal is to be informed on an unsuccessful resource reservation needed for providing the quality of service, and a unit informing the terminal depending on the decision result.

According to aspects of that apparatus,
the apparatus is a network card, network entity, chipset, terminal, or module;
the apparatus further comprises a deciding unit configured to decide whether a terminal is QoS aware;
the apparatus comprises a checking unit configured to check usage of pre-conditions in session description protocol for deciding whether the terminal is QoS-aware.

A System comprising an apparatus of a network entity as defined above, and an apparatus of a terminal as defined above.

A Computer program product or module loadable into a network entity or terminal, comprising portions for executing the method of any one of the method aspects as defined above or below

A method, comprising receiving an indication message indicative of an unsuccessful radio resource reservation.

According to aspects of that method,
the indication message is a “network busy” message;
transmitting a notice that QoS aware is supported by a terminal and that the terminal is to be informed on unsuccessful resource reservation;
wherein the resource reservation is for establishing access bearer of a system architecture evolution (SAE);
wherein the indication message is from a mobile management unit using a direct transfer mechanism;
the method comprises at least one of: running at least one application, such as a QoS aware application; and providing information about failure in resource reservation to the application;
wherein the QoS application is a SIP application, the notice of QoS aware and/or indication message of unsuccessful resource reservation are included in SDP (session description protocol) offer and SDP answer;
the method further comprises canceling a session setup, or using a default QoS, or renegotiating session parameters, in response to the information about failure;
wherein an application is able to request QoS, and a terminal is able to modify a QoS request to a secondary PDP context request when the terminal is attached to 3G access network;
wherein the network is a System Architecture Evolution, SAE, or LTE, long term evolution, network;
wherein the received information on successful or unsuccessful resource reservation is transferred to an application layer;
the method further comprises deciding whether a terminal is QoS aware;
the method further comprises checking usage of pre-conditions in session description protocol for deciding whether the terminal is QoS-aware;
wherein the message is a SIP protocol message.
wherein the quality of service is specified by pre-conditions.

An apparatus, comprising means for deciding on quality of service, QoS, to be used for information flow between a network and a terminal, means for deciding on whether the terminal is to be informed on an unsuccessful resource reservation needed for providing the quality of service, and means for informing the terminal depending on the decision result.

An apparatus, comprising means for receiving information about failure regarding resource reservation.

The invention will be described in the following with reference to embodiments and the drawings, without being limited to the details described and shown.

### BRIEF DESCRIPTION OF THE DRAWINGS

FIG. 1 shows an example of a functioning of a second generation, third generation 2G/3G terminal,

FIG. 2 shows an example of a method and functions in a terminal being applicable to a SAE/LTE structure and functions,

FIGS. 3 to 5 illustrate embodiments for a case of fully network controlled resource reservation, with and without notification of a terminal, and

FIGS. 6, 7 show further embodiments of the invention.

### DETAILED DESCRIPTION OF EMBODIMENTS

Embodiments described in the following show how the network will give or send enough information for the terminal and how the terminal may transfer internally the information to the application.

In an embodiment complying e.g. with the SAE/LTE the network has full control of QoS and the terminal is automatically given only the radio L2 information, which is required to map services to right radio bearers. Even in a case where there is no L3 QoS negotiation between core network and the terminal, the network will send enough information for the terminal.

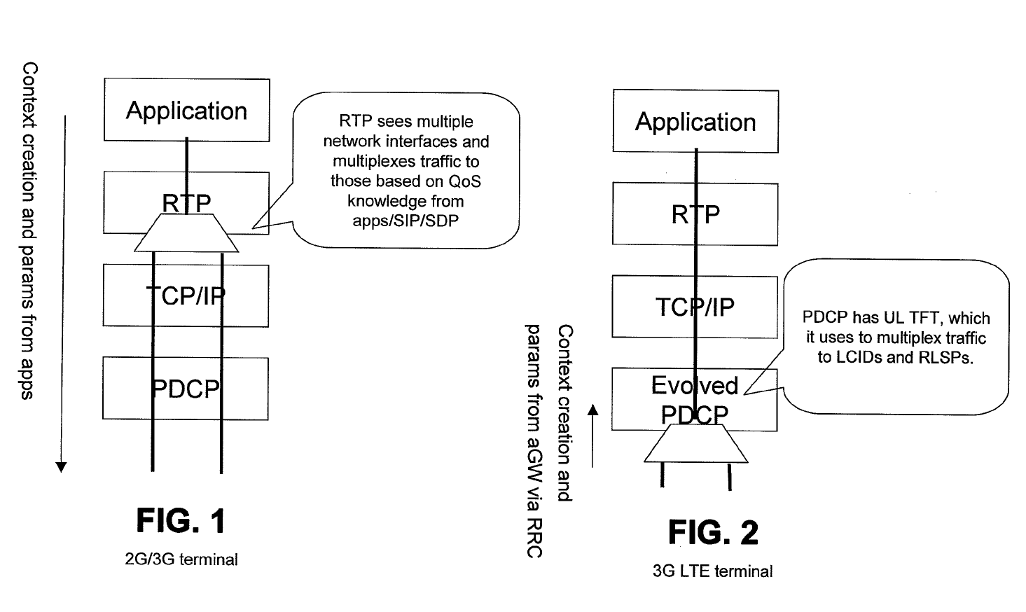

FIGS. 1, 2 show embodiments of terminal implementations which present the base principles how the QoS information and the failure information may be handled in a multimode terminal with QoS aware application.

In case of successful SAE bearer setup, there is a NAS message piggy packed into radio bearer setup message, which includes uplink Traffic Flow Template (UL TFT) as well as application specific guaranteed bit rate information. The latter parameter is used only if the created SAE bearer is a GBR bearer.

If the bearer setup is not successful, radio bearer setup does not take place. A QoS aware terminal may have a timer to detect that the QoS information did not arrive in time and based on the timer expiration understand that no bearer setup took place. The timer solution may not be very useful in all cases because it is difficult to set a reliable value to the timer.

Instead, according to one or more embodiments of the invention, in case of unsuccessful resource reservation an entity or device of the network such as a Mobility Management Entity (MME) can have responsibility to inform the terminal on the unsuccessful reservation by sending information such as a “network busy”-message to the terminal, preferably or optionally using direct transfer.

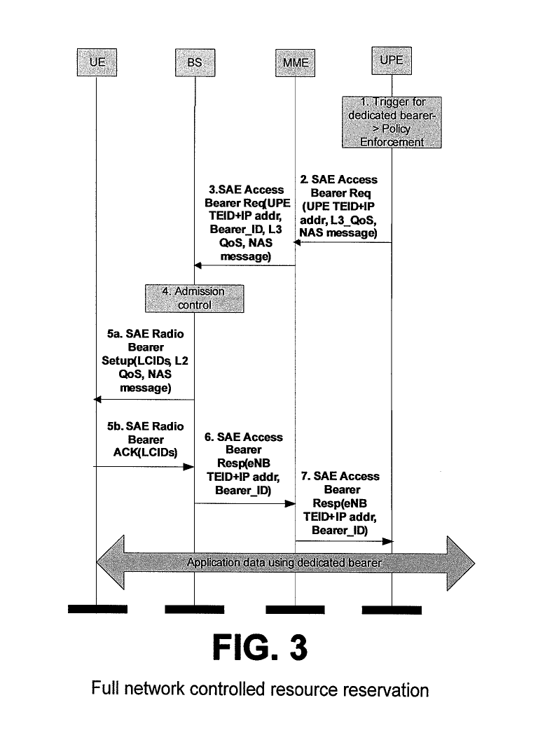

The principles of that solution are described with reference to FIGS. 3 to 5. It is possible, that each time when a dedicated bearer setup fails, the entity MME sends the “network busy”-message, dependent on the terminal capabilities. In case of QoS aware terminal, the information is transferred to the application. Otherwise the information is discarded. This solution is simple, fast and reliable from an MME implementation point of view, but may cause unnecessary signalling, in cases where the information is not used in the terminal. A part of the unnecessary signalling can be reduced if the MME knows whether the terminal is QoS aware or not. There may still be applications which are not QoS aware, in a QoS aware terminal. Therefore only the information of the terminal type in MME can not remove all the unnecessary signalling.

In order to avoid unnecessary signalling in cases where the information is not used in the terminal, the unnecessary signalling can be suppressed if the device such as MME knows whether the terminal is QoS aware or not, and uses this information for deciding on sending the failure information to the terminal. When the device such as MME knows that the terminal is QoS aware, the device will send the failure information to the terminal. Otherwise, if the device such as MME knows that the terminal is not QoS aware, the device such as MME will decide not to send the failure information to the terminal so as to avoid unnecessary signaling.

In a case where at least one application exists or is invoked in a QoS aware terminal which application are not QoS aware, the usage of a failure indicator such as a “network busy” indicator or the like is preferably restricted in one or more embodiments to such cases like IMS SIP in which both the terminal and the application such as a SIP application are QoS aware.

FIGS. 1, 2 show terminal implementations and present the basic principles how the QoS information and the failure information may be handled in the multimode terminal with QoS aware application. In case of successful SAE bearer setup, there is an information such as a NAS message piggy packed into radio bearer setup message, which may include an uplink Traffic Flow Template as well as application specific guaranteed bit rate information. The latter parameter is used only if the created SAE bearer is a GBR bearer. If the bearer setup is not successful, radio bearer setup does not take place.

FIGS. 1, 2 illustrate some basic differences between a 2G/3G and a 3G LTE terminal. Layers between PDCP and applications are referred to as a “connectivity layer” in these drawings.

FIG. 1 shows a context creation and parameters from applications in a 2G/3G terminal, the context creation proceeding downwards according to FIG. 1. As shown in FIG. 1, a real-time transport protocol, RTP, sees multiple network interfaces and multiplexes traffic to those based on QoS knowledge from apps/SIP/SDP.

FIG. 2 shows a context creation and parameters from aGW via RRC in a SAE/LTE terminal, the context creation proceeding upwards according to FIG. 2. PDCP has uplink traffic flow template, UL TFT, which it uses to multiplex traffic to LCIDs and RLSPs.

FIG. 1 shows an application behavior in a QoS aware terminal in pre-LTE. When an application requires better QoS, the request is processed in the layer 3 of the terminal to a secondary packet data protocol, PDP, context request. A PDP context request is sent to serving GPRS support node, SGSN. The terminal (connectivity layer) and application are aware of the requested QoS. When the secondary PDP context setup is ready, SGSN sends a PDP context response message to the terminal. Connectivity layer is able to do a mapping between the application and the secondary PDP context and informs the application about the status of QoS (reserved bit rate etc.). With reference to FIG. 2 an application behavior according to an embodiment of the invention in a terminal such as a 3G LTE terminal is described.

It is assumed that the application does not see a difference between 3G and 3G LTE accesses. When the application notices that better QoS is required, it sends the request as in 3G.

The connectivity layer is aware of the current access technology. Because in 3G LTE, the terminal is not allowed to request QoS, the connectivity layer stores the information of requested QoS, but does not signal this information to the network. Application level signalling has caused the network to initiate resource reservation. When the resource reservation is ready, the application specific QoS information is given in NAS-message for the terminal in the radio bearer setup signalling.

If the resource reservation fails, a direct transfer from MME to the terminal user equipment, UE, is used to transfer failure information. The connectivity layer of the terminal will always receive the information. It is up to the applications and middleware of the terminal whether the information is used or not.

The RRC layer passes the NAS-message to the connectivity layer, where the allocated QoS is bound to a right application level request. The allocated QoS is given as a response for the requesting application. From application point of view this is same as a secondary PDP context response had arrived.

The SAE bearers are not visible on the connectivity layer, only the application specific QoS information. The uplink Traffic Flow Template (TFT) provided by network is used for mapping of application and QoS information.

With reference to FIGS. 3 to 5, further embodiments are described.

According to at least one of the embodiments, the invention proposes that in case of unsuccessful resource reservation an entity such as Mobility Management Entity (MME) will have responsibility to inform the terminal by sending an information such as a “network busy”-message to the terminal, preferably using direct transfer.

The principles of this embodiment are described and shown in FIGS. 3 to 5, and provide a full network controlled resource reservation. It is possible, that each time when a dedicated bearer setup fails, MME sends a “network busy”-message, dependent on the terminal capabilities.

A user plane entity, UPE, shown in FIGS. 3 to 5 combines LTE anchor and 3GPP anchor, where IP address is allocated, L2 tunnel is terminated, and PCEF is located.

The steps or messages shown in FIG. 3 will be described in the following.

In step 1, either detection of application level signaling or a new UL/DL flow triggers the policy enforcement in UPE. UPE requests MME to create dedicated SAE Access bearer for this particular service.

In step 2, the SAE Access Bearer request includes UPE TEID+IP address, L3 QoS, GBR (aggregate) and NAS message [UL TFT, QoS information required by application, header compression configuration].

In step 3, MME initiates the dedicated SAE bearer setup. It allocates SAE Bearer ID for the bearer. Otherwise the message includes same parameters as the message 2.

In step 4, a base station, BS, performs admission control for GBR services.

In step 5, in SAE Radio Bearer setup message there are DL and UL Logical Channel IDs, L2_QoS and the NAS message [UL TFT, QoS information required by application, header compression configuration]. The UL TFT information is needed on PDCP layer to map the service data to a right radio bearer. In case of QoS aware terminal, UL TFT is used in connectivity layer to map the application specific GBR for with the right application.

In step 6, SAE Access Bearer response informs MME about the success of radio resource reservation. This message contains eNB TEID+IP address as well as SAE Bearer_ID.

In step 7, MME responses the UPE SAE Bearer request. Parameters in this message are the same as in the previous. The dedicated bearer is ready and application data is mapped to that.

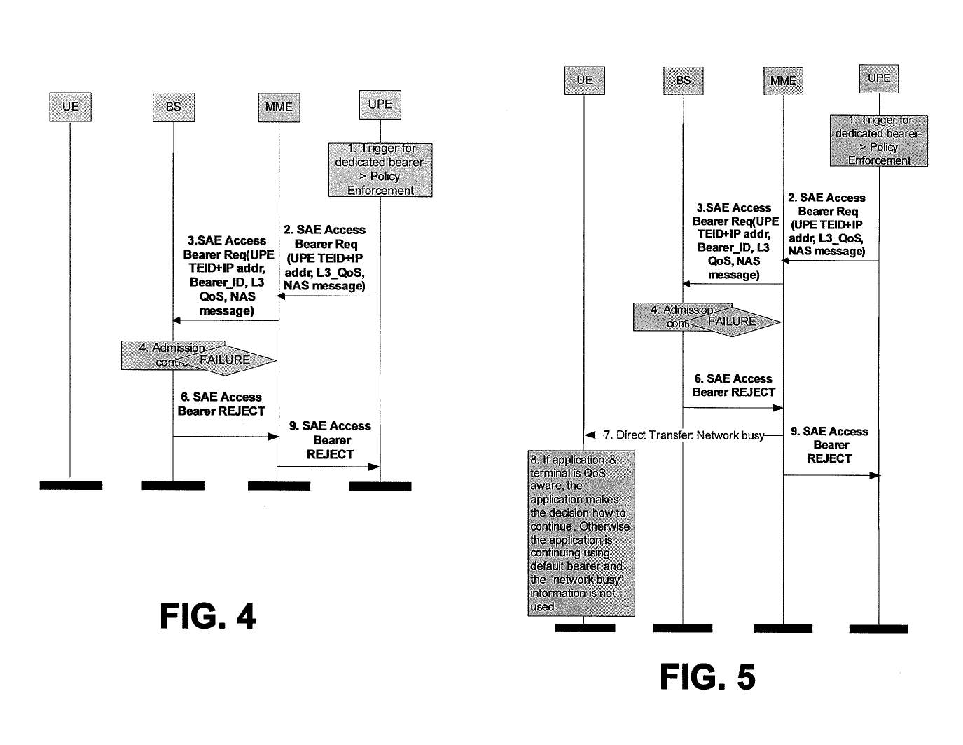

FIG. 4 shows a case where, without any additional intelligence, in case of failure in SAE bearer setup, no information about bearer setup is given to the terminal. Thus, a failure may occur without notification to the UE. This behavior is acceptable in cases where the application is not waiting for feedback. This behavior does however not support the usage of QoS aware applications implemented for 3G terminals. With reference to the steps carried out and the information transmitted, see the inscriptions in this and any other of the drawings of the present document.

FIG. 5 shows an embodiment where an entity of the network such as a MME informs the terminal UE about a failure.

In case that there is a failure in dedicated SAE bearer setup, the MME is responsible of sending an e.g. “Network busy”-indication to the terminal using direct transfer mechanism, as shown in step 7. “Network busy”-message is an indicator that the network was not able to create dedicated SAE bearer with requested QoS. MME includes an uplink traffic flow template, UL TFT, to the “network busy”-message.

It depends on the terminal and application capabilities how this information is treated. If there is no QoS intelligence, the information is treated as waste and the application data always continues using default bearer. In other case, the “network busy” information gives the possibility for the QoS aware application to decide whether to continue using default QoS, re-start the session negotiation or simply abandon the session.

In QoS aware terminal, the information is transferred to the application (otherwise the information is discarded). This solution is simple in MME implementation point of view, but may cause some unnecessary signalling, in cases where the information is not used in the terminal. A part of the unnecessary signalling can be reduced if the MME would know whether the terminal is QoS aware or not. There might still be applications, which are not QoS aware in QoS aware terminal. Therefore only the information of the terminal type in MME can not remove all the unnecessary signalling.

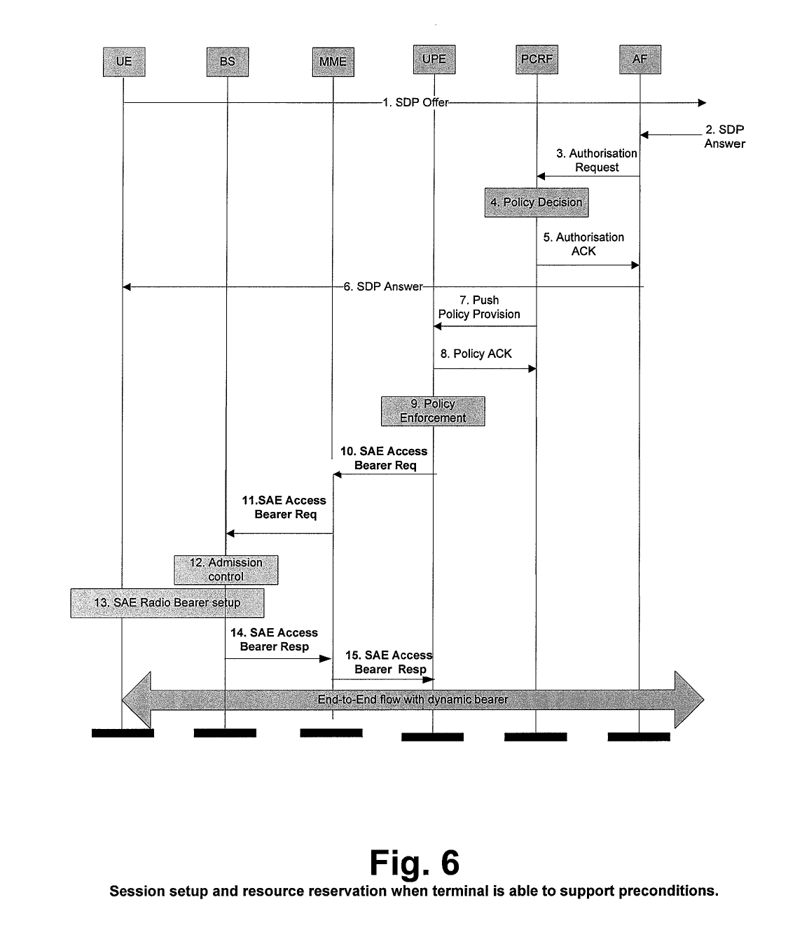

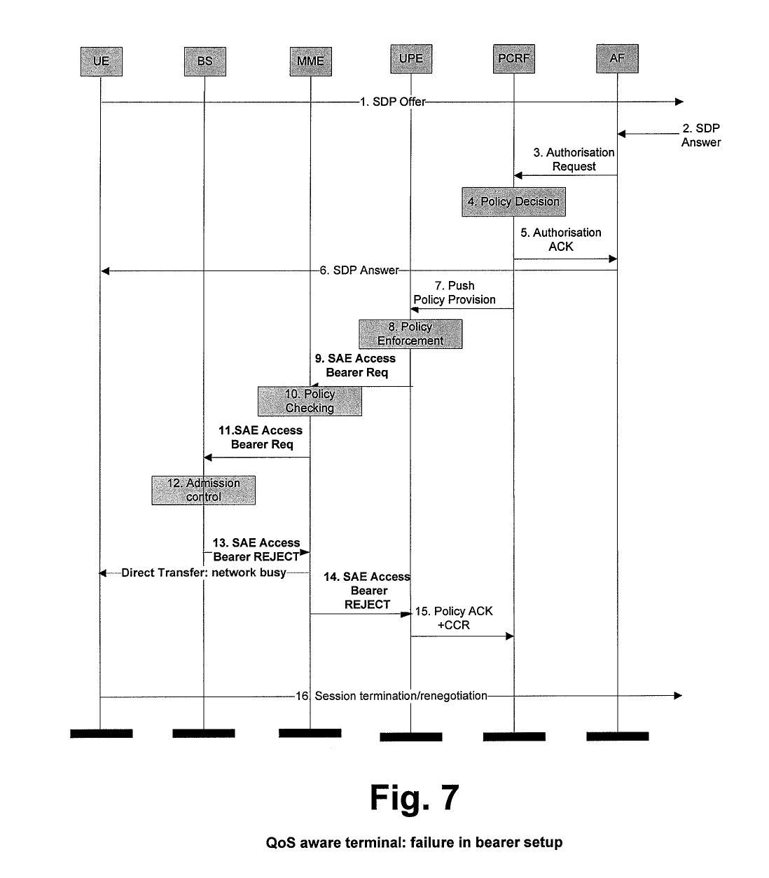

Embodiments shown in FIGS. 6, 7 and described below illustrate a solution with session initiation protocol, SIP, with pre-conditions. This is an improved solution and presents a method, device and model where the usage of a “network busy” indicator is restricted to the IMS SIP in case that terminal and SIP application is QoS aware. This embodiment is therefore improved and reduces unnecessary signalling.

The embodiments of FIGS. 6, 7 generally relate to media transmission such as IMS VoIP or IMS streaming, preferably with protocol signalling such as SIP signalling.

FIG. 6 presents a signalling flow for SIP session setup when terminal is QoS-aware. The usage of pre-conditions in SDP Offer gives AF information that the terminal is QoS aware, and the terminal is waiting for feedback about resource reservation before completing the session establishment signalling.

If the bearer setup is successful, the response is given as GBR information within NAS package in SAE Radio Bearer setup. In case that the SAE bearer is rejected by eNB or some other node, the negative response (“network busy”-information) is sent from MME to terminal using direct transfer.

Note that if pre-conditions are used in streaming session setup signalling, the pre-conditions should be met before the session is able to start (i.e. early transfer is not possible). Therefore the same signalling flow is valid for both VoIP and streaming. The streaming application is getting the allocated GBR information during the successful SAE bearer setup.

UPE in this document is a combined device such as an LTE anchor and 3GPP anchor where IP address is allocated, L2 tunnel is terminated and PCEF is located.

A L3 QoS negotiation between a core network and the terminal may be provided. When not as in a SAE/LTE network where QoS is controlled by the network, it may be the network, which starts resource reservation, and an unsuccessful reservation indication (“network busy”) arrives to UE without any request.

In embodiments of this invention the network indicates an unsuccessful reservation to a QoS aware terminal based on the information from policy decision point (PCRF). I.e. the policy decision includes information on whether the application/terminal is waiting for a response. See the embodiment of FIGS. 6, 7, using SIP with pre-conditions optimised solution. In at least one of the embodiments, the SAE/LTE network indicates an unsuccessful reservation in any case.

When eNB responds with SAE Access Bearer REJECT to MME's SAE Access Bearer request (i.e. REJECT instead of building up the radio link) MME answers UPE bearer request with REJECT: MME knows that for the particular bearer ID the terminal is waiting for response. MME sends a “network busy” indicator to the UE using direct transfer. “Network busy”-message is an indicator that network is not able to provide dedicated resources with the requested QoS. The message has to include UL TFT.

FIG. 6 shows an embodiment providing session setup and resource reservation when the terminal is able to support preconditions.

In step or message 1, an SDP Offer (INVITE) is sent by caller to callee via AF (IMS).

In step or message 2, the callee answers with SDP answer. AF notice that the preconditions are supported and resource reservation requested. AF may indicate that notifications about bearer events are required.

In step or message 3, an AF asks authorisation from PCRF and indicates the support for preconditions.

In step 4, a PCRF performs policy decision for the session. Because of support for preconditions, the authorisation is acknowledged straight after policy decision in step or message 5.

In step or message 6, an SDP answer can now be forwarded at this stage to the caller without risk of having a too early alert in the caller side. When the caller gets SDP answer, it sets a terminal internal QoS request and waits for the response. Session negotiation is continued only after the QoS response.

In step or message 7, a Policy decision is pushed to the UPE. In case of a further enhanced solution this message contains information, that application/terminal is waiting for response. (Only QoS aware SIP application is able to support preconditions).

In step or message 8, a Policy decision can be answered straight or after message 15.

In step or message 9, an UPE performs policy enforcement for the session.

In step or message 10, UPE requests MME to initiate dedicated bearer establishment. SAE Access Bearer Request consist of L3 QoS, UPE TEID and IP address, GBR (aggregate), bearer_ID and a piggypacked NAS message with TFT, header compression configuration and QoS information required by applications/services. If an optimized solution is used, UPE should set “response requested by UE” bit as 1, because the application is waiting for the QoS response.

In step or message 11, MME allocates the bearer_ID and initiates the bearer establishment. The message 11 contains the same parameters as message 10+bearer_ID. In case of optimized solution “Response requested by UE” bit is not mandatory in this message, because there is no use for that in eNB.

In step 12, the eNB performs admission control. It can either accept or reject the requested bearer, but is not able to modify the requested QoS. In case that the eNB rejects the bearer, phase or step 13 is not performed.

In step or message 13, if the bearer is accepted, Radio Bearer is established. The terminal is given only information about priority of the bearer, and TFT to map the right service to a right radio bearer. Additionally the service specific QoS information is given to the terminal and forwarded in the terminal to the particular application waiting for QoS response. When this information is given to the application, it has enough knowledge to continue the SIP signalling and is able to send UPDATE-message to the callee.

In step or message 14, SAE Access Bearer response can be either negative or positive. In case that the bearer is established, the response is positive. If the response is negative and the UE is waiting for response, MME sends “network busy” indication to the terminal using direct transfer.

In step or message 15, the message is negative or positive depending on the success of the bearer setup. Note, that there may be a failure already between MME and UPE. Then the signals or messages 11 to 14 are not sent, but only the “network busy”-indication to the terminal (in case that the terminal is waiting for response) and the message 15.

In that case, the voice connection is opened only with sufficient resources, as shown by the double-headed arrow.

FIG. 7 shows an embodiment similar to FIG. 6 but for a case in which a QoS aware terminal encounters a failure in bearer setup.

FIG. 7 presents the behaviour in a case that the access network is not able to support the requested dedicated bearer. Messages 1 to 11 are identical to the steps or messages 1 to 11 of FIG. 6.

In step 12, the eNB is not able to allocate the requested radio resources.

In step or message 13, eNB sends a reject message such as SAE Access Bearer REJECT for MME instead of building up the radio link. Note, that in this case the terminal is not getting any TFT of GBR information.

When the REJECT arrives at MME, MME knows that for the particular bearer ID the terminal is waiting for response. MME sends an information to the terminal UE such as “network busy” indicator using direct transfer in order to inform the terminal on the failed bearer setup. A “Network busy”-message is an indicator that network is not able to provide dedicated resources with the requested QoS. The message has to include UL TFT.

In step or message 14, MME answers UPE bearer response message with REJECT.

In step or message 15, UPE sends a policy acknowledgement with information to remove the charging bindings.

The invention thus provides at least according to some of the embodiments, an architecture where the QoS in controlled by the network only instead of negotiating it between the terminal and the network (e.g. QoS/bearer needed due IMS streaming request from a terminal), and the network makes a decision whether or not the terminal needs an indication of unsuccessful radio resource reservation (e.g. if QoS aware terminal/application, e.g. a legacy application from 2G/3G networks used in multimode terminal).

In case of full network controlled resource reservation, the terminal is not allowed to request QoS. In case of successful bearer setup, the SAE radio bearer setup messaging is used to transfer QoS information to the terminal. If the bearer setup fails, the terminal is thus automatically getting an indication of the failure.

If an application running in terminal would not be aware of failure in resource reservation then the end user's quality of experience may be compromised. According to an implementation of the invention, an application such as a QoS aware application can thus be provided with information about failure in resource reservation to be able to gracefully cancel a session setup or to renegotiate the session parameters if default QoS is not to be concerned for the application. Without failure indication QoS aware applications may have unstable behavior when waiting for resource reservation feedback before completing the session setup.

In case of IMS VoIP, the network is able to terminate the session setup in case of resource reservation failure to prevent “ghost calls” without sufficient resources. If the QoS awareness of the application is supported with the failure indication, the session setup is not necessarily terminated, but the decision how to continue is left for the application itself.

SAE/LTE can be implemented on top of existing network, and most likely the first terminals are multimode terminals supporting LTE and 2G/3G access technologies. The QoS mechanism in 3G networks provides support from the terminal and applications and therefore the future multimode terminal preferably have QoS capabilities for 3G access network usage. The applications are able to request QoS and the terminal is able to modify the QoS request to secondary PDP context request when the terminal is attached to 3G access network.

An application running in a terminal can be made aware of failure in resource reservation so as to avoid any disadvantage as to the end user's quality of experience. A QoS aware application is provided with the information about failure in resource reservation to be able to gracefully cancel a session setup or to renegotiate the session parameters if default QoS is not to be concerned for the application. Without failure indication QoS aware applications may have unstable behavior when waiting for resource reservation feedback before completing the session setup. In case of IMS VoIP, network is able to terminate the session setup in case of resource reservation failure to prevent “ghost calls” without sufficient resources. If the QoS awareness of the application is supported with the failure indication, the session setup is not necessarily terminated, but the decision how to continue is left for the application itself.

The embodiments of the invention illustrate example as to how the information of non-successful resource reservation can be transmitted to the terminal in LTE.

The invention solves the problem of QoS aware application usage in terminals such as an e.g. 2G/3G/3G LTE capable terminal. Embodiments incorporate the behaviour or features required by terminal and network to transfer information of successful or unsuccessful resource reservation in the network that controls QoS, so as to transfer the information of successful or unsuccessful resource reservation up to the application layer. At least one or more of the embodiments of the invention shows how the network will give enough information for the terminal and how the terminal transfers internally the information to the application.

In the SAE/LTE the network has full control of QoS and the terminal is automatically given only the radio L2 information, which is required to map services to right radio bearers.

Embodiments of the invention make it possible to support QoS aware applications in LTE. One example of QoS aware application is SIP application supporting preconditions signalling. Embodiments re-use the current 3G application implementation. It helps to build multi-radio terminals, with minimal or no changes to the application behaviour. (Application is not required to adjust its behaviour to the currently used access technology).

Embodiments may re-use the layer 3 intelligence, already implemented for 3G terminals (some modification required). The proposed solution without optimisation is able to support all kind of QoS aware applications, not only SIP applications. With the optimisation described, the proposed solution does not add any unnecessary signalling to the network. The proposed solution without optimisation may be implemented using some signalling to the network.

The functionality described is visible when network sends failure indication to terminal.

As described above, a communication system and network entities as well as communication devices and methods are provided wherein a network may have control of QoS. An information such as a “network busy” message may be sent to a terminal, dependent on the terminal capabilities such as QoS aware or not, if a dedicated bearer setup fails.

One or more embodiments of the invention thus provide a network entity, apparatus, network, or method, comprising: triggering a policy enforcement in a user plane entity using an application level signaling or a new uplink or downlink flow;

transmitting a system architecture evolution (SAE) access bearer message request to a mobile management entity to create a dedicated SAE access bearer for a particular service;

initiating a set-up for the dedicated SAE access bearer at the mobile management entity and transmitting the message request from the mobile management entity to a base station;

performing an admission control for guaranteed bit rate information services at the base station;

transmitting a message from the base station to a terminal to perform a dedicated SAE bearer set-up;

transmitting a response message to the mobile management entity indicative of a successful radio resource reservation; and

based on the response message, transferring the information to the application or discarding at the terminal the information and continuing to use a default bearer.

The message request to the mobile management entity may comprise a user plane entity tunnel endpoint identifier and internet protocol address, a layer 3 quality of service, a guaranteed bit rate and a non-access stratum message, including an uplink traffic flow template, quality of service information required, or a header compression configuration. The message request to the base station may comprise a user plane entity tunnel endpoint identifier and internet protocol address, a layer 3 quality of service, a guarantee bit rate and a non-access stratum message, including an uplink traffic flow template, quality of service information required, a header compression configuration, or a SAE bearer identification.

The response message may comprise an evolved Node B tunnel endpoint identifier and internet protocol address and a SAE bearer identification.

The access bearer message may comprise a layer 3 quality of service, a user plane entity tunnel endpoint identifier and internet protocol address, a guaranteed bit rate, a bearer identification, a piggy packed non-access stratum message with a traffic flow template, a header compression configuration, and quality of service information required by applications or services.

An apparatus, terminal, or a method of or provided in a terminal may comprise:

in response to a detection of a failure in an admission control for guaranteed bit rate information services to create a dedicated system architecture evolution access bearer for a particular service, receiving a network busy message indicative of an unsuccessful radio resource reservation using a direct transfer mechanism;

when no quality of service awareness exists, discarding information in the network busy message and continuing to use a default bearer; and

when quality of service awareness exists, based on the information in the network busy message, determining whether to continue using a default quality of service, restart a session negotiation, or abandon a session.

When a reject message is received at a mobile management entity indicative of the failure detection, there my be further provided:

determining at the mobile management entity that for a particular bearer, the terminal is waiting for a response; transmitting from the mobile management entity to the terminal the network busy message to inform the terminal of a failed bearer setup, wherein the network busy message indicates that a network is unable to provide dedicated resources with a requested quality of service and comprises an uplink traffic flow template.

The network busy message may comprise at least one of an indicator that the network is unable to create the dedicated system architecture evolution bearer with a requested quality of service, a downlink and uplink logical channel identifier message, a layer 2 quality of service message, and a non-access stratum message.

One or more embodiments of a method, apparatus, or entity for or in a network, may comprise:

triggering a policy enforcement in a user plane entity using an application level signaling or a new uplink or downlink flow;

transmitting a system architecture evolution (SAE) access bearer message request to a mobile management entity to create a dedicated SAE access bearer for a particular service;

initiating a set-up for the dedicated SAE access bearer at the mobile management entity and transmitting the message request from the mobile management entity to a base station;

performing an admission control for guaranteed bit rate information services at the base station;

detecting a failure in the admission control;

transmitting a message from the base station to the mobile management entity indicative of an unsuccessful radio resource reservation; and

transmitting a network busy message from the mobile management entity to the terminal using a direct transfer mechanism.

The network busy message may comprise an indicator that the network is unable to create the dedicated SAE bearer with a requested quality of service.

When no quality of service awareness exists in the terminal, there may be further provided:

discarding the network busy message at the terminal and continuing to use a default bearer or determining at the terminal whether to continue using a default quality of service, restart a resource reservation negotiation, or abandon the resource reservation negotiation.

The apparatus or method, when quality of service awareness exists in the terminal, may further comprise:

transferring the information to the application or discarding at the terminal the information and continuing to use a default bearer.

A terminal, apparatus, or method for a terminal may comprise, in accordance with one or more or all of the embodiments of the invention:

transmitting a notice that pre-conditions are supported by the terminal and that a resource reservation is requested;

receiving a session description protocol answer;

in response to a detection of an admission control for guaranteed bit rate information services, establishing a system architecture evolution (SAE) access bearer for a particular service; and
transmitting a SAE access bearer message indicative of whether a network is able to provide dedicated resources with a requested quality of service.

If the SAE access bearer message is negative, and the terminal is waiting for a response, the method or apparatus may further comprise:

receiving a network busy message that the network is unable to provide dedicated resources with the requested quality of service.

When a reject message is received at a mobile management entity indicative that the SAE access bearer message is negative, the method or apparatus may further comprise:

determining at the mobile management entity that for a particular bearer, the terminal is waiting for a response;

transmitting from the mobile management entity to the terminal a network busy message to inform the terminal of a failed bearer setup, wherein the network busy message indicates that a network is unable to provide dedicated resources with a requested quality of service and comprises an uplink traffic flow template.

After receiving the session description protocol answer, there may be further provided:

setting at the terminal an internal terminal quality of service request and waiting for a quality of service response; and

continuing session negotiation after the quality of service response is received.

The method or apparatus may further comprise:

when the terminal receives the session description protocol answer, setting at the terminal an internal terminal quality of service request and waiting for a response, and continuing session negotiation after the quality of service response is received.

The access bearer message may comprise at least one of a layer 3 quality of service, a user plane entity tunnel endpoint identifier and internet protocol address, a guaranteed bit rate, a bearer identification, a piggy packed non-access stratum message with a traffic flow template, a header compression configuration, and quality of service information required by applications or services.

The method or apparatus may further comprise:

receiving information about priority of the access bearer, the traffic flow template to map a service to an appropriate radio bearer, or a service specific quality of service information.

One or more embodiments of an apparatus, terminal or method for a terminal, may comprise:

transmitting a notice that pre-conditions are supported by the terminal and that a resource reservation is requested;

receiving a session description protocol answer;

in response to a detection of an admission control for guaranteed bit rate information services, requesting a system architecture evolution (SAE) access bearer establishment for particular radio resources;

determining that the terminal is unable to allocate the requested radio resources;

transmitting a reject message to a mobile management entity indicative that the terminal is unable to allocate the requested radio resources; and

receiving a network busy message indicative of an unsuccessful radio resource reservation from the mobile management unit using a direct transfer mechanism.

The terminal may in one or more embodiments not be provided with traffic flow template or guaranteed bit rate information.

After transmitting the reject message, there may be further provided:

setting an internal terminal quality of service request and waiting for a quality of service response; and

continuing session negotiation after a quality of service response is received.

The network busy message may comprise information indicative of a failed bearer setup and that the network is unable to provide dedicated resources with a requested quality of service, and may comprise an uplink traffic flow template.

The method or apparatus may further comprise:

generating a policy acknowledgement with information to remove charging bindings.

The terminal may be a SAE or LTE terminal, or can also be any other kind of terminals in communication systems.

For implementing the invention, any of the above described features or the features shown in the drawings can be used in any arbitrary combination. The scope of the invention encompasses any of these arbitrary combinations, and any modifications available to a skilled person. The invention may also be implemented on a software basis or be provided as a software module which can be loaded in a network entity or terminal so as carry out at least some of the described functions when loaded into a computer or processor of a terminal or other entity.

In this description, the term multi-radio terminal refers to a terminal which can be used in 2G/3G as well as 3G LTE access networks. This terminal can be for example a network card used as a modem with laptop or a mobile handset like current mobile phones.

### LIST OF ABBREVIATIONS

### AF Application Function

### aGW Access Gateway

eNB evolved NodeB

### MME Mobility Management Entity

### NAS Non-Access Stratum

### PCEF Policy and Charging Enforcement Function

### PDCP Packet Data Convergence Protocol

### RLSP Radio Link Service Profile

### RRC Radio Resource Control

### RTSP Real Time Streaming Protocol

UPE User Plane Entity. In this description it refers to a combined LTE anchor and 3GPP anchor.

### SDP Session Description Protocol

SIP Session Initiation Protocol.

1. A method, comprising:
deciding, on quality of service, to be used for information flow between a network and a terminal,
deciding, on whether the terminal is to be informed on an unsuccessful resource reservation needed for providing the quality of service, and
informing the terminal depending on the decision result.

2-38. (canceled)

39. The method of claim 1, wherein the decision on whether the terminal is to be informed on an unsuccessful resource reservation is based at least in part on a message received from the terminal.

40. The method of claim 1, wherein the network is a System Architecture Evolution, or long term evolution, network, and the resource reservation is a radio resource reservation.

41. The method of claim 1, wherein the network sends an indication message to inform the terminal about the success or failure of the resource reservation.

42. An apparatus, comprising:
a receiving unit configured to receive information regarding failure of resource reservation for establishing an access bearer;
a platform adapted to run at least one application; and
a processor configured to inform the at least one application with information about failure in resource reservation.

43. The apparatus of claim 42, the at least one application further configured to cancel a session setup, or to use a default quality of service, or to renegotiate session parameters, in response to the information about failure.

44. The apparatus of claim 42, further comprising
a transmitting unit configured to send a notice that a quality of service aware feature is supported by the apparatus.

45. The apparatus of claim 42, wherein the at least one application is able to request quality of service and the apparatus is adapted to modify a quality of service request to a secondary packet data protocol context request when the apparatus is attached to a network permitting packet data protocol context.

46. The apparatus of claim 42, wherein the apparatus is a System Architecture Evolution or long term evolution terminal.

47. The apparatus of claim 42, wherein the apparatus is adapted to transfer received information on successful or unsuccessful resource reservation to an application layer.

48. The apparatus of claim 42, wherein the apparatus is adapted to receive an indication message to inform the apparatus about the success or failure of the resource reservation if a dedicated bearer setup fails.

49. An apparatus, comprising:
a unit configured to decide on quality of service, to be used for information flow between a network and a terminal;
a unit configured to decide on whether the terminal is to be informed on an unsuccessful resource reservation needed for providing the quality of service; and
a unit configured to inform the terminal depending on the decision result.

50. The apparatus of claim 49, further comprising:
a deciding unit configured to decide whether a terminal is quality of service aware.

51. The apparatus of claim 49, further comprising:
a checking unit configured to check usage of pre-conditions in session description protocol for deciding whether the terminal is quality of service aware.

52. Computer program product comprising at least one computer-readable storage medium having computer-readable program instructions stored therein, the computer-readable program instructions comprising:
a program instruction for deciding, on quality of service, to be used for information flow between a network and a terminal;
a program instruction for deciding, on whether the terminal is to be informed on an unsuccessful resource reservation needed for providing the quality of service; and
a program instruction for informing the terminal depending on the decision result.

53. Computer program product comprising at least one computer-readable storage medium having computer-readable program instructions stored therein, the computer-readable program instructions comprising:
a program instruction for receiving an indication message indicative of an unsuccessful radio resource reservation for establishing an access bearer; and
a program instruction for informing the application with information about failure in resource reservation

54. A method, comprising:
receiving an indication message indicative of an unsuccessful radio resource reservation for establishing an access bearer; and
providing information about failure in resource reservation to at least one application.

55. The method of claim 54, further comprising:
transmitting a notice that quality of service aware is supported by a terminal and that the terminal is to be informed on unsuccessful resource reservation.

56. The method of claims 54, wherein the at least one application is a session initiation protocol application, and the notice of at least one of quality of service aware and indication message of unsuccessful resource reservation being included in session description protocol offer and session description protocol answer.

57. The method of claim 54, further comprising at least one of:
cancelling a session setup;
using a default quality of service; and
renegotiating session parameters, in response to the information about failure.

58. The method of claim 54, wherein an application is able to request quality of service, and a terminal is able to modify a quality of service request to a secondary packet data protocol context request when the terminal is attached to 3G access network.

59. The method of claim 54, wherein the received information is transferred to an application layer to inform the application successful or unsuccessful resource reservation.

60. The method of claim 55, further comprising:
checking usage of pre-conditions in session description protocol for deciding whether the terminal is quality of service aware.
